(19) United States
(12) Patent Application Publication
(10) Pub. No.: US 2013/0068980 A1
(43) Pub. Date: Mar. 21, 2013

(54) ROTARY VALVE ASSEMBLY FOR AN INJECTION NOZZLE

(71) Applicant: Maciej Brelski, Brampton (CA)

(72) Inventor: Maciej Brelski, Brampton (CA)

(73) Assignee: Husky Injection Molding Systems Ltd., Bolton, ON (CA)

(21) Appl. No.: 13/509,691

(22) PCT Filed: Oct. 28, 2010
(86) PCT No.: PCT/CA10/01690

§ 371 Date: May 14, 2012

Related U.S. Application Data
(60) Provisional application No. 61/265,855, filed on Dec. 2, 2009.

(51) Int. Cl. B29C 45/23; F16K 5/18

(52) U.S. Cl. 251/304

(57) ABSTRACT

A rotary valve assembly is provided for an injection unit, comprising a valve body defining a melt channel for a working fluid. The valve body and at least one end cap define a valve seat having a wider diameter portion and at least one thinner diameter portion. A spool assembly is rotatably mounted within the valve seat and movable between an open position where an orifice is aligned with the melt channel and a closed position where the orifice is misaligned with the melt channel. The spool assembly includes a center spool portion defining the orifice, and at least one arm spool portion connected on a side of the center spool portion, the at least one arm spool portion being translatable relative to the center spool portion by the working fluid entering the gap located therebetween.

### TECHNICAL FIELD

The present generally relates to molding systems; more specifically, the present relates to rotary valve assemblies for the injection nozzle for the molding system.

### BACKGROUND

The injection molding process usually comprises preparing a polymeric material in an injection unit of an injection molding machine, injecting the now-molten material under pressure into a closed and clamped mold that is water cooled, solidifying the material in its molded shape, opening the mold and ejecting the part before beginning the next cycle. The polymeric material typically is supplied to the injection unit from a hopper in the form of pellets or powder. The injection unit transforms the solid polymeric material into a molten material, typically using a feed screw, which is then injected into a hot runner or other molding system under pressure from the feed screw or a plunger unit. A shut off valve assembly is typically provided to stop and start the flow of molten material from the barrel to the molding system.

Numerous types of valve assemblies can be used, including sliding piston valves and rotary valves. An example of a prior art sliding piston valve assembly for an injection unit can be found in U.S. Pat. No. 4,140,238 to Dawson (published Feb. 20, 1979). An example of a prior art rotary valve assembly for an injection unit can be found in U.S. Pat. No. 4,054,273 to Neuman (published Oct. 18, 1977).

Efforts have been made to improve the rotary valve assembly. European patent 0 494 304 B1, entitled “Rotary Valve of Injection Molding Machine” to YOKOTA, Akira et al. (published on Sep. 7, 1994) teaches a rotary valve assembly of an injection molding machine provided with a cylindrical valve chamber formed in the flow passage in which molten resin is filled under pressure and through which molten resin flows from the screw side to the nozzle side, wherein a cylindrical valve body having a through hole radially piercing through the body for ensuring unobstructed flow through the flow passage so that the through hole may agree with the axial line of the cylindrical valve chamber is fitted into the valve chamber slidably around the axial line and circumferential grooves are formed in the circumferential direction on both sides of the through hole and located along the axial line of the cylindrical valve body on the peripheral surface thereof so that even a small driving torque can actuate the cylindrical valve body.

Japanese patent 09123218A, entitled “Shutoff Nozzle for Injection Molding Machine” to MASATAKA et al (published on May 13, 1997) teaches: In an extrusion molding machine shut-off nozzle made capable of rotation between a position in which a molten resin passage is connected and a position in which the molten resin passage is cut off, and a housing is provided at some position along the nozzle having the molten resin passage whereby molten to resin is fed to a metal mold from an extrusion molding machine, with rotary means provided at the end of a cylindrical rotary valve that has a through-hole in the interior of said housing and is freely rotatably inserted; a pressure reducing valve that temporarily admits molten resin left on a hot runner prior to commencement of suck-back is arranged in a direction intersecting the nozzle.

U.S. Pat. No. 7,614,71, entitled “Rotary Valve Assembly for an Injection Nozzle” to Condo (published on Jan. 15, 2009) teaches a rotary valve assembly for an injection unit, having a valve body, defining a melt channel for a working fluid. At least one end cap is mounted to the valve body, the valve body and the at least one end cap cooperatively defining a valve seat intersecting the melt channel in a generally traverse direction, the valve seat having a wider diameter portion and a narrower diameter portion. A spool defines an orifice, the spool being rotatably mounted within the valve seat, and is movable between an open position where the orifice is aligned with the melt channel and a closed position where the orifice is misaligned with the melt channel.

### SUMMARY

According to a first broad aspect, there is provided a rotary valve assembly for an injection unit, comprising:

a valve body defining a melt channel for a working fluid;

at least one end cap, mounted to the valve body, the valve body and the at least one end cap defining a valve seat having a wider diameter portion and at least one narrower diameter portion;

a spool assembly defining an orifice, the spool assembly being rotatably mounted within the valve seat and movable between an open position where the orifice is aligned with the melt channel for expressing the working fluid through the melt channel and a closed position where the orifice is misaligned with the melt channel to prevent expressing the working fluid through the melt channel; and

wherein the spool assembly includes a center spool portion defining the orifice, and at least one arm spool portion connected on a side of the center spool portion, the at least one arm spool portion being translatable relative to the center spool portion by the working fluid entering a gap located therebetween.

### BRIEF DESCRIPTION OF THE DRAWINGS

A better understanding of the non-limiting embodiments (including alternatives and/or variations thereof) may be obtained with reference to the detailed description of the non-limiting embodiments along with the following drawings, in which

FIG. 1 shows a perspective view of a portion of an injection unit for a molding system in accordance with a first non-limiting embodiment;

FIG. 2 shows a side cross-sectional view of the injection unit shown in FIG. 1;

FIG. 3 shows a front cross-sectional view of a rotary valve assembly for the injection unit shown in FIG. 1;

FIG. 4 shows a front cross-sectional view of a spool for a rotary valve assembly in accordance with another non-limiting embodiment; and

FIG. 5 shows a front cross sectional view of a portion of a rotary valve assembly in accordance with another non-limiting embodiment.

### DETAILED DESCRIPTION OF THE PREFERRED EMBODIMENT(S)

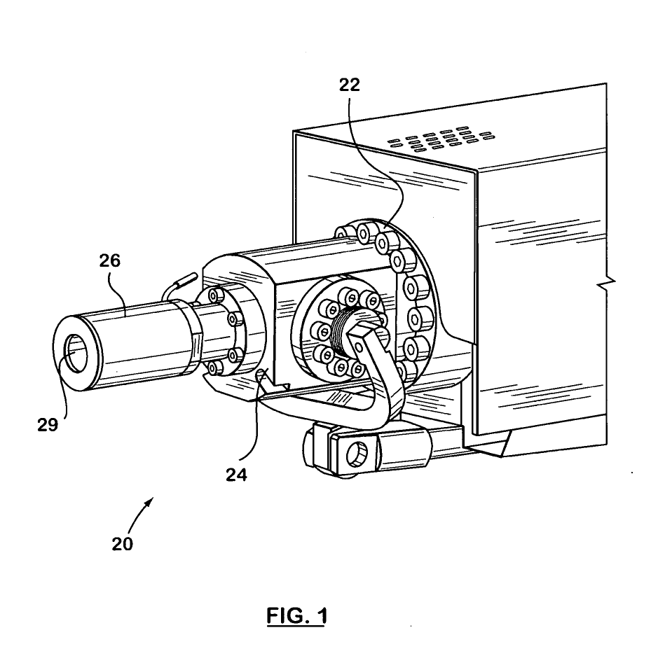

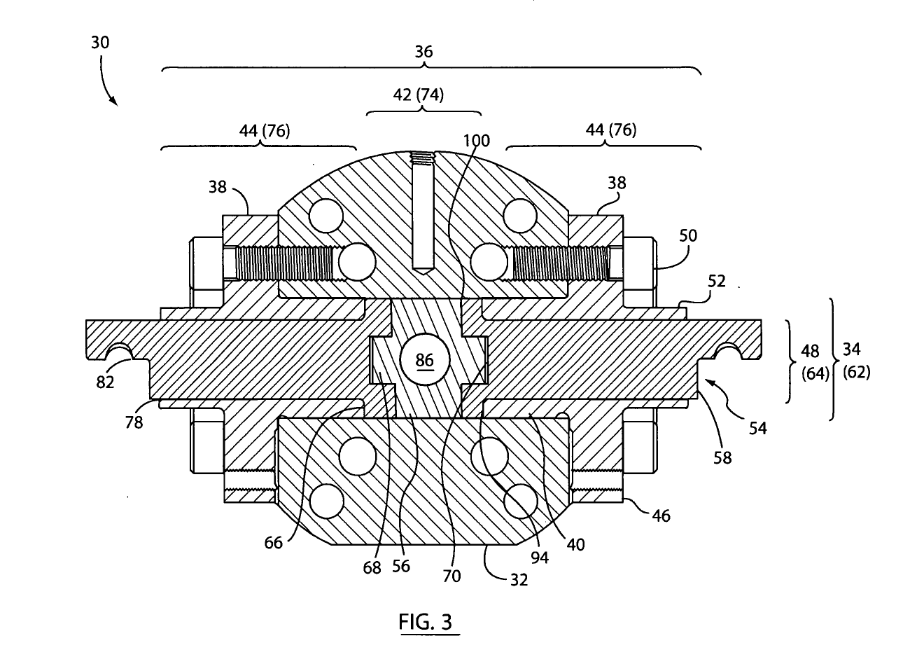

Referring now to FIGS. 1-3, an injection unit for a molding system is shown generally at 20, in accordance with a first non-limiting embodiment. The injection unit 20 includes an extrusion barrel 22 adapted to receive a screw (not shown), a shut-off head 24 closing off the end of extrusion barrel 22, and a nozzle 26, all coaxially aligned. A melt channel 28 is defined between them, extending through extrusion barrel 22, shut-off head 24 and nozzle 26. A working fluid, typically a molten material such as a PET resin is expressed through melt channel 28 from extrusion barrel 22, through shut-off head 24, and then exits through an outlet 29 on nozzle 26.

A rotary valve assembly 30 is provided that is operably movable between an “open” position, where the molten resin is able to flow freely through melt channel 28 and exit through the outlet 29, and a “closed position”, where the molten resin is blocked from exiting outlet 29. Rotary valve assembly 30 includes shut-off head 24, which defines a valve body 32. An outer bore 34 is defined within valve body 32 that bisects melt channel 28 in a generally traverse direction.

A pair of end caps 38 are located partially within outer bore 34 on opposing sides of valve body 32. Each end cap 38 includes a cylindrical insert portion 40, which extends into outer bore 34. A flange portion 46 on each of the end caps 38 limits the distance that the end cap 38 can he inserted into outer bore 34. Fasteners 50 are used to securely mount the end caps 38 to valve body 32, and to prevent rotation of the end caps 38. An extension portion 52 on each of the end caps 38 is a hollow cylinder on the side of flange portion 46 opposite insert portion 40. An inner bore 48, having a smaller diameter than outer bore 34, extends through the centre of end cap 38, making each inner bore 48 concentric with outer bore 34.

The outer bore 34 and the inner bore 48 in each end cap 38 cooperate to define a valve seat 36. Valve seat 36 includes a wider diameter portion 42 and at least one narrower diameter portion 44. In the presently-illustrated embodiment, valve seat 36 includes a pair of narrower diameter portions 44 located on opposing sides of wider diameter portion 42. The portion of outer bore 34 between the two insert portions 40 defines the wider diameter portion 42 of valve seat 36, and each inner bore 48 defines one of the narrower diameter portions 44 of the valve seat 36 so that the wider diameter portion 42 is flanked on both sides by each narrower diameter portion 44. The wider diameter portion 42 is preferably located within the centre of valve body 32 so that melt channel 28 bisects the wider diameter portion 42. With the end caps 38 mounted to both sides of valve body 32, in the presently-illustrated embodiment, each of the two inner bores 48 is longer than outer bore 34. However, it is also contemplated that inner bores 48 could be sized longer or shorter than outer bore 34.

A spool assembly 54 is rotatably located within valve seat 36. In the currently-illustrated embodiment, spool assembly 54 is defined by a center spool portion 56 and at least one arm spool portion 58. In the currently-illustrated embodiment, the at least one arm spool portion 58 is pair of arm spool portions 58 located on opposing sides of the center spool portion 56. Center spool portion 56 is generally cylindrical and defines a key 68 on at least one end of the cylinder, and in the currently-illustrated embodiment, defines a key 68 on both ends of the cylinder. Those of skill in the art will recognize that the implementation of key 68 is not particularly limited and can include splines, hex faces, square faces, etc.

Each arm spool portion 58 includes a first diameter section 62 and a second diameter section 64. The first diameter section 62 is sized to have a larger diameter than the second diameter section 64, and in the currently-illustrated embodiment, is sized to have the same diameter as center spool portion 56 to jointly define a thicker region 74 that is seated within wider diameter portion 42 of the valve seat 36 (i.e., outer bore 34). The second diameter sections 64 define thinner regions 76, which are sized as to be seated within the narrower diameter portion 44 (i.e., the inner bore 48). For example, a spool assembly 54 could have a diameter of 54 mm in the thicker region 74, and a diameter of 35 mm in each thinner region 76, reducing the total surface area of spool assembly 54 over a continuous-diameter spool assembly 54 having the diameter of thicker region 74.

A step 66 is located between the first diameter section 62 and the second diameter section 64. On each first diameter section 62 opposite the center spool portion 56 is a key slot 70 sized to frictionally fit the key 68, thereby kinematically coupling the center spool portion 56 and the arm spool portions 58 together so that they rotate in tandem. Key slot 70 can be deeper than key 68 so that the key 68 does not bottom out at the base of the key slot 70.

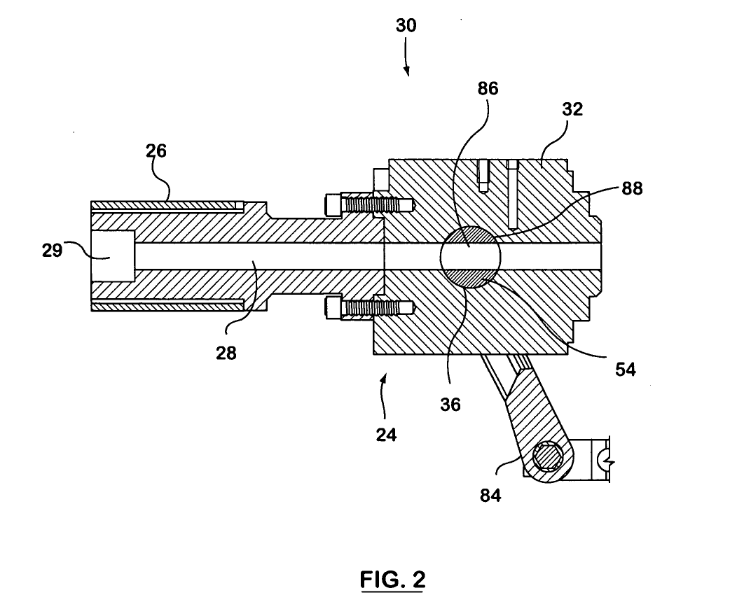

An orifice 86 is defined in center spool portion 56. When spool assembly 54 is in the open position, orifice 86 is aligned to be coaxial with melt channel 28, permitting the throughput of molten material. When spool assembly 54 is in the closed position, orifice 86 is rotated away from melt channel 28 so that a land 88 on spool assembly 54 (FIG. 2) prevents the molten material from flowing. Preferably, each of the thinner regions 76 extends fully through their respective inner bores 48, and past an outside edge 78 of the valve seat 36. The two ends 82 of spool assembly 54 are adapted to be attached to an actuator arm 84 (FIG. 2). Movement of the actuator arm 84 by an actuator (not shown) moves spool assembly 54 between the open and closed positions. While the presently-illustrated embodiment shows a spool assembly 54 having a pair of thinner regions 76 extending beyond outside edges 78, it is contemplated that a spool assembly 54 could be provided where only one thinner region 76 or neither extends past outside edge 78.

Spool assembly 54 is sized so that it can rotate freely within valve seat 36. A clearance gap is provided between the sidewall of spool assembly 54 and the adjacent portion of outer bore 34 or inner bore 48 to allow rotation of rotary valve assembly 30. However, leakage of the molten material along clearance gap and out through the outside edge 78 remains a constant issue. Leaking molten material spreads along the clearance gap, where a portion of the molten material will force its way into the gap between center spool portion 56 and at least one of the arm spool portions 58. As leakage along clearance gap is unlikely to be symmetrically distributed, it will likely reach one arm spool portion 58 before reaching the other arm spool portion 58. As the molten material enters a gap 100 between the center spool portion 56 and the arm spool portion 58 it begins to partially separate the two (i.e., the arm spool portion 58 is translated relative to the center spool portion 56) so that the steps 66 on arm spool portions 58 are pressed against a sealing face 94 defined on the end of flange portion 46. The greater the leakage becomes, the greater the sealing force increase. The end caps 38 limit the separation of arm spool portions 58 from center spool portion 56 so that key 68 does not exit one of the key slots 70.

To assemble rotary valve assembly 30, one of the end caps 38 is first removed. Then, the spool assembly 54 (typically already assembled from its constituent center spool portion 56 and arm spool portions 58) is inserted into valve body 32 with the leading thinner region 76 slid through the inner bore 48 on the remaining end cap 38. Once in place, the detached end cap 38 can be re-mounted, and secured tightly by fasteners 50. Spool assembly 54 is constrained from non-rotational movement.

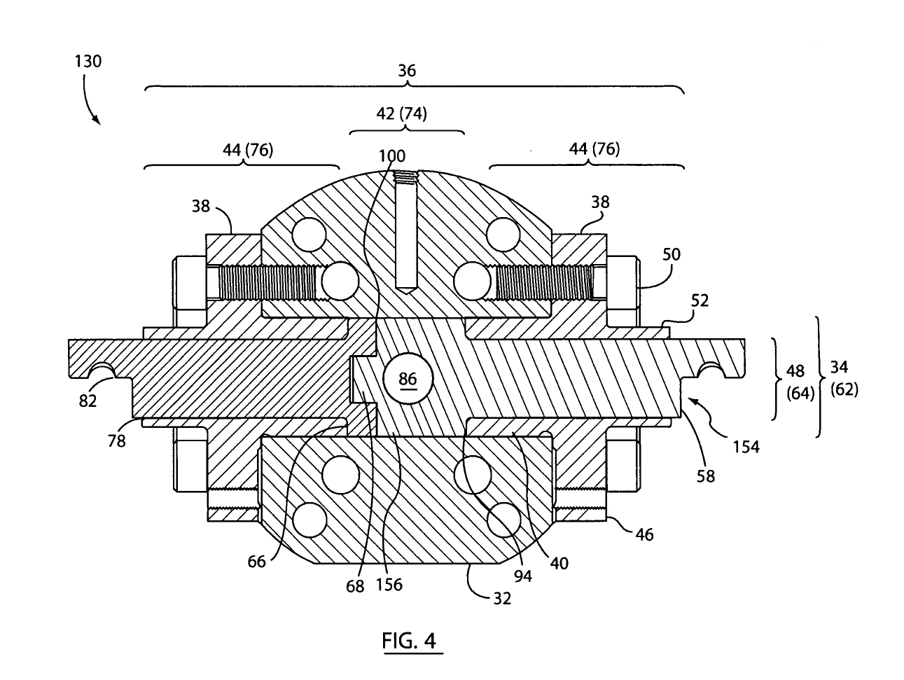

Variations in the rotary valve design can be applied. For example, in the embodiment of rotary valve assembly 130 shown in FIG. 4, a spool assembly 154 rotatably located within valve body 32 is manufactured from two pieces instead of three. A center spool portion 156 that includes a thinner portion 64 extending through one side of the inner bore 48. The center spool portion 56 includes only a single key 68. Mounted to the center spool assembly 156 is an arm spool 58 as is described above. Spool assembly 154 thus includes only a single gap 100.

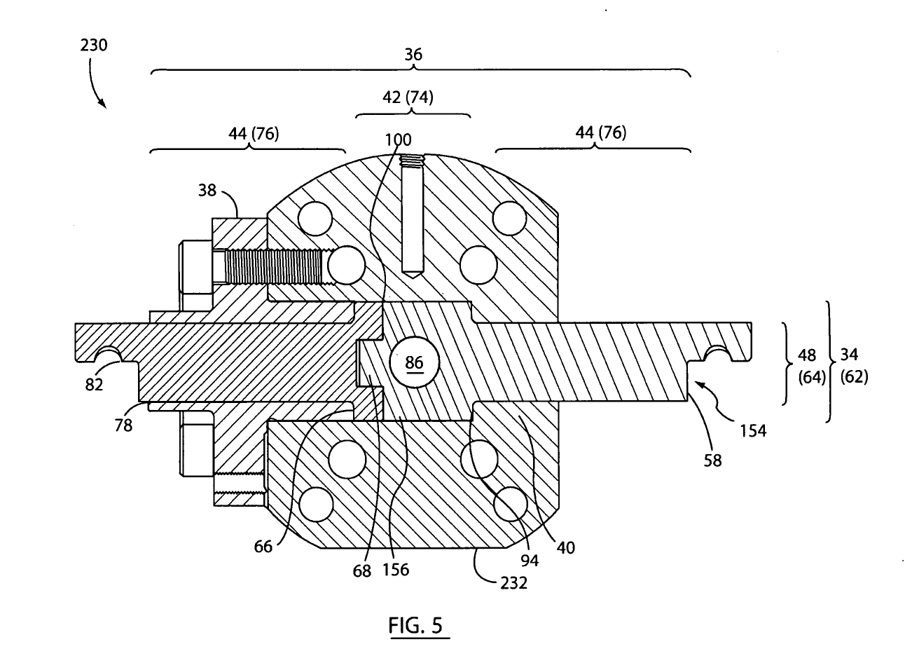

Another variation of the rotary valve design includes a valve body having only a single end cap 38. Referring now to FIG. 5, another non-limiting embodiment is shown generally at 230.

In this embodiment of rotary valve assembly 230, valve body 232 defines both the inner bore 48 (i.e., one narrower diameter portion 64) and the outer bore 34 (i.e., the wider diameter portion 42) on one side of the valve seat 36. On the other side of the valve seat 36, an end cap 38 is used in the manner described above. Those of skill in the art will recognize that the two-part spool assembly 154 (as shown) or the three-part spool assembly 54 could be seated within valve body 232.

Other adaptations can be made to reduce leakage around the valve seat. For example, concentric grooves and/or sealing rings can be provided along the lengths of thinner region 76 (not shown). Alternatively, a collet (not shown) can be provided on the outside of the end caps 38 to reduce leakage outside of the valve body. Arm spool portions 58 can also include drainage holes to relieve pressure between the centre spool portion 56 and arm spool portions 58.

The description of the non-limiting embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the non-limiting embodiments, it will be apparent that modifications and enhancements are possible without departing from the concepts as described. Therefore, what is to be protected by way of letters patent are limited only by the scope of the following claims.

What is claimed is:

1. A rotary valve assembly for an injection unit, comprising:
a valve body defining a melt channel for a working fluid;
at least one end cap, mounted to the valve body, the valve body and the at least one end cap defining a valve seat having a wider diameter portion and at least one narrower diameter portion;
a spool assembly defining an orifice, the spool assembly being rotatably mounted within the valve seat and movable between an open position where the orifice is aligned with the melt channel for expressing the working fluid through the melt channel and a closed position where the orifice is misaligned with the melt channel to prevent expressing the working fluid through the melt channel; and
wherein the spool assembly includes a center spool portion defining the orifice, and at least one arm spool portion slidably mounted to a side of the center spool portion, the at least one arm spool portion being translatable relative to the center spool portion by the working fluid entering a gap located therebetween.

2. The rotary valve assembly of claim 1, wherein the spool assembly includes a first diameter section adapted for the wider diameter portion of the valve seat and a second diameter section adapted for a narrower diameter portion of the valve seat

3. The rotary valve assembly of claim I, wherein the working fluid entering the gap located between the center spool portion and the at least one arm spool portion forces the at least one arm spool portion against a sealing face formed by the at least one end cap.

4. The rotary valve assembly of claim 1, wherein the spool assembly includes a first diameter section adapted for the wider diameter portion of the valve seat and a second diameter section adapted for a narrower diameter portion of the valve seat and further includes a step between the first diameter section and the second diameter section.

5. The rotary valve assembly of claim 1, wherein the at least one end cap defines an insert portion which extends coaxially into an outer bore defined by the valve body, the insert portion defining a land for the spool assembly to be forced against due to leakage of the working fluid.

6. The rotary valve assembly of claim 1, wherein the valve seat includes a pair of narrower diameter portions, and each narrower diameter portion of the pair of narrower diameter portions are located on opposing sides of the wider diameter portion.

7. The rotary valve assembly of claim 6, wherein one narrower diameter portion of the pair of narrower diameter portions is defined within the valve body.

8. The rotary valve assembly of claim 6, wherein the at least one end cap includes a pair of end caps mounted on opposing sides of the valve body, and each of the pair of narrower diameter portions are defined by the pair of end caps.

9. The rotary valve assembly of claim 1, wherein the at least one arm spool portion is a pair of arm spool portions slidably mounted to opposing sides of the center spool portion.

10. The rotary valve assembly of claim 1, wherein the center spool portion defines a key on at least one side of the center spool portion.

11. The rotary valve assembly of claim 10, wherein the at least one arm spool portion is a slot adapted to receive the key defined by the center spool portion.
